(19) United States
(12) Patent Application Publication
(10) Pub. No.: US 2025/0020369 A1
(43) Pub. Date: Jan. 16, 2025

(54) CRYOGENIC REFRIGERATION DEVICE

(71) Applicant: L'Air Liquide, Societe Anonyme pour l'Etude et l’Exploitation des Procedes Georges Claude, Paris (FR)

(72) Inventors: Camille BOUVIER, Sassenage (FR); Luc GAFFET, Sassenage (FR); Olivier GUIA, Sassenage (FR)

(73) Assignee: L'Air Liquide, Societe Anonyme pour l'Etude et l’Exploitation des Procedes Georges Claude, Paris (FR)

(21) Appl. No.: 18/710,058

(22) PCT Filed: Oct. 7, 2022
(86) PCT No.: PCT/EP2022/077914

§ 371 Date: May 14, 2024

(30) Foreign Application Priority Data
Nov. 17, 2021 (FR) FR 2112151

(51) Int. Cl. F25B 9/10; G01N 1/42

(52) U.S. Cl. CPC F25B 9/10; G01N 1/42

(57) ABSTRACT

A cryogenic refrigeration device is provided that may include: an enclosure delimiting a vacuum-sealed volume closed by a cover; and at least one cryogenic refrigerator mounted through the cover and having a first end situated outside the enclosure and a second end situated inside the enclosure, the cryogenic refrigerator being configured to supply cold at its second end. The device can also include at least two thermally conductive plates distributed according to a direction of distribution within the enclosure and forming thermal stages, at least some of the plates being cooled by the cryogenic refrigerator to respective determined temperatures decreasing in the direction of distribution, at least one of the plates being connected to a heat screen forming a volume that encompasses at least one following plate, the cryogenic refrigerator being of the type using a cold source of liquefied cycle fluid such as helium or nitrogen, at least some of the plates being cooled by the cycle fluid via a set of heat exchangers that exchange heat with said plates and with a flow of the cycle fluid.

### CROSS REFERENCE TO RELATED APPLICATIONS

This application is a § 371 of International PCT Application PCT/EP2022/077914, filed Oct. 7, 2022, which claims the benefit of FR2112151, filed Nov. 17, 2021, both of which are herein incorporated by reference in their entireties.

### FIELD OF THE INVENTION

The invention relates to a cryogenic refrigeration device.

In certain embodiments, the invention relates more particularly to a cryogenic refrigeration device comprising an enclosure delimiting a vacuum-sealed volume closed by a cover, the device comprising at least one cryogenic cooler mounted through the cover and having a first end located outside the enclosure and a second end located inside the enclosure, the cryogenic cooler being configured to supply cold at its second end, the device comprising at least two thermally conductive plates distributed in a distribution direction in the enclosure and forming thermal stages, at least some of the plates being cooled by the cryogenic cooler to respective predetermined temperatures which decrease in the distribution direction, at least one of the plates being connected to a thermal shield forming a volume which encloses at least one following plate, the cryogenic cooler being of the type which uses a cold source of liquefied cycle fluid such as helium or nitrogen.

The invention relates to a refrigeration device for cooling elements to a cryogenic temperature below 100 K, and notably below 50 K and/or below 4 K.

Specifically, the invention relates to refrigeration devices used to cool to very low temperatures, in the order of millikelvins (“sub-kelvin refrigeration”). These very low temperatures are conventionally obtained using a dilution refrigerator or a cryogenic cooler of the He4 or He3 Joule-Thomson type.

### BACKGROUND OF THE INVENTION

In such devices it is necessary to supply a cooling power to a temperature of, for example, 4 K to one or more refrigeration stages.

This cooling power must also be able to rapidly cool the device (cooling down from a hot state). The device must also be able to be reheated for the purpose of maintenance, for example.

Known dilution refrigerators require cooling powers at least to 4.2 K in order to function. This cooling power is conventionally obtained from cryogenic refrigerators of the pulse tube type or the like, which are referred to as “dry”. According to another solution, referred to as “wet”, a bath of liquid helium is used in the enclosure to cool the plates or the like. This solution presents problems of managing the sealing between the various parts, which complicates access for the samples and cables in the enclosure. These known “wet” solutions also require relatively long cooling and reheating times.

Some applications (cooling of qubits, for example) require an increase in the necessary cooling power to approximately 4.2 K. The cooling powers of pulse tubes are limited and not very suitable.

An objective of the present invention is to eliminate all or some of the above-described disadvantages of the prior art.

### SUMMARY OF THE INVENTION

In an effort to overcome the deficiencies of the prior art discussed, supra, the device according to certain embodiments of the invention, while corresponding to the general definition given in the preamble above, can include at least some of the plates that are cooled by the cycle fluid via a set of heat exchangers in heat exchange with said plates and with a flow of the cycle fluid.

In addition, embodiments of the invention can comprise one or a plurality of the following characteristics:
the set of heat exchangers in heat exchange with said plates comprises a plurality of separate heat exchangers associated with the plates, the exchangers of at least two plates being mechanically connected to one another,
said heat exchangers are arranged and spaced apart in the distribution direction, the distribution direction being vertical in the operating position in the enclosure,
said heat exchangers are mounted in the enclosure via the same passage in the cover, for example via the same support flange of the cover,
the heat exchangers comprise a block of thermally conductive material, for example of copper, in contact with a tube of thermally conductive material, for example of copper, transporting the cycle fluid flow, said tube being soldered to the block and/or machined in the block and/or molded and/or cast in the block,
at least some of the heat exchangers are mounted on the plates and are in heat exchange with said plates by conduction and contact, via at least one of the following: bolting, at least one thermal connecting braid, a clamp,
at least some of the set of heat exchangers are arranged in a sealed casing delimiting a volume that is independent of the remainder of the volume of the enclosure,
at least some of the heat exchangers are in heat exchange with said plates without being in contact with the plates but via an intermediate gas, for example a gas containing at least one of the following: helium, nitrogen, argon or hydrogen,
at least some of the heat exchangers comprise a layer of gilt configured to increase the heat exchange,
the cryogenic cooler comprises a refrigerator having a cycle of refrigeration of a cycle fluid, said refrigerator comprising a cycle circuit composed of the following elements arranged in series: a mechanism for compressing the cycle fluid, at least one member for cooling the cycle fluid, a mechanism for expanding the cycle fluid, and at least one member for reheating the expanded cycle fluid, in which the cycle fluid comprises at least one of the following: helium, hydrogen, nitrogen, argon, the cycle circuit being configured to subject the cycle fluid to a thermodynamic cycle which brings the cycle fluid at at least one end of the cycle circuit to a predetermined cold temperature, the cycle fluid flow in heat exchange with said plates in the set of heat exchangers comprising the cycle fluid at the cold temperature, the device comprising a set of pipes for supplying at least part of the fluid from the cycle circuit to the set of exchangers and for returning said fluid from the set of exchangers to the cycle circuit of the refrigerator,
the cycle circuit is configured to subject the cycle fluid to a thermodynamic cycle which brings the cycle fluid to a plurality of separate cold temperatures at a plurality of ends of the cycle circuit, a plurality of separate flows of the cycle fluid at said separate cold temperatures being placed in heat exchange with the at least two separate plates via two respective sets of heat exchangers,
the cycle fluid is or contains predominantly helium, the cycle circuit being configured to bring the cycle fluid to at least one of the following cold temperatures: approximately 80 K, between 20 and 70 K, between 2 K and 5 K, and/or into a supercritical state,
the cryogenic cooler comprises a reserve of liquefied cryogenic gas, for example of liquid nitrogen, and a set of pipes for supplying liquefied cryogenic gas from the reserve to the set of exchangers,
the device comprises a dilution refrigerator in heat exchange with at least one plate,
the plates are made of a thermally conductive material, for example copper or any other alloy or any suitable material,
the plates can be spaced apart from one another by rods of low thermal conductivity,
the plates are configured to be the support for various apparatuses or samples which are to be cooled to a low temperature,
the device comprises one or more electrically insulating elements which provide electrical insulation between the enclosure and the cooler.

The invention relates also to a method for cryogenic refrigeration of sample(s) using a cryogenic refrigeration device according to any one of the characteristics above or below, comprising a step of storing and/or producing a cold source of liquefied cycle fluid such as helium or nitrogen at the first end of the cryogenic cooler, a step of transferring a flow of that cycle fluid from the first end to the second end of the cryogenic cooler, said flow of cycle fluid being placed in heat exchange with the set of heat exchangers at the second end in a sealed manner without communicating with the internal gas volume of the enclosure.

The invention can also relate to any alternative device or method comprising any combination of the characteristics above or below within the context of the claims.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Further particular features and advantages will become apparent upon reading the following description, which is provided with reference to the figures, in which:

FIG. 1 is a schematic partial vertical cross-section view of an exemplary embodiment of a cooling device according to the invention,

FIG. 2 is a partial schematic view of an exemplary embodiment of a cryogenic cooler which can be used in such a cooling device,

FIG. 3 is a schematic partial vertical cross-section view of another exemplary embodiment of a cooling device according to the invention.

### DETAILED DESCRIPTION OF THE INVENTION

The cryogenic refrigeration device 1 shown comprises an enclosure 2 delimiting a vacuum-sealed volume closed by a cover 3.

The device 1 comprises at least one cryogenic cooler 4 mounted through the cover 3 and having a first end located outside the enclosure 2 and a second end located inside the enclosure 2.

The cryogenic cooler 4 is configured to supply cold at its second end. For example, a or the cooling power is stored and/or produced at the first end of the cryogenic cooler.

The first and second ends of the cryogenic cooler can form a single physical entity. In a variant or in combination, the cooling power could be produced in another installation/device (another physical entity) and transferred to the first end, for example by a heat transfer fluid or any other thermal transfer member. Thus, the cooling power (or cold source) is produced or stored outside the enclosure 2.

At least some of this cooling power can be transferred from the first end to the second end.

The cryogenic cooler 4 is, for example, a refrigerator of the type which uses a cycle fluid subjected to a thermodynamic cycle in a closed cycle circuit (other than a dilution refrigerator). The cycle fluid is brought to a relatively colder temperature at a cold end of the cycle in order to provide cooling power. At least part of the cycle circuit can be located outside the enclosure 2, especially the cold end. Thus, the cycle fluid is cooled outside the enclosure 2 and can be circulated in the enclosure in order to provide cooling power there (at at least one plate 5, 6, 10). The cooling power is thus produced outside the enclosure 2. The reheated cycle fluid which has undergone heat exchange with the plates in the enclosure 2 can return outside the enclosure in order to be cooled again (the cycle starts again). In particular the compression and expansion members of the cycle can be located outside the enclosure 2.

This configuration limits the number of components of the cryogenic refrigerator 4 in the enclosure 2 under vacuum, which preferably comprises a dilution refrigerator. This makes it possible for a very high vacuum to be provided in the enclosure 2, which is favorable to the dilution refrigerator. This limits the risk of leakage and increases the operating time of the dilution refrigerator.

The device 1 comprises in this example three thermally conductive plates 5, 6, 10 distributed vertically in the enclosure 2 and forming thermal stages at predetermined temperatures. The plates are configured to receive and to cool elements or samples.

The device 1 preferably comprises a set of passages 17 formed through the cover 3 and the plates 5, 6 for the sealed passage of cable(s) and/or equipment into the enclosure 2.

At least some of the plates 5, 6 (two in this example) are cooled by the cryogenic cooler 4 to predetermined temperatures which decrease from top to bottom (for example a first plate 5 can be cooled to a temperature of between 20 K and 80 K, especially about 50 K, and the other plate 6 can be cooled to a temperature of between 2 K and 5 K, especially about 4 K).

The invention is not limited to this embodiment and other configurations for the plates are possible. For example, the plates could be thermalized at a temperature which decreases from bottom to top, or they could be arranged in a horizontal direction and be thermalized at temperatures which decrease from left to right or vice versa or according to another distribution.

As shown, the plate(s) 5, 6 can be connected to a thermal shield 19, 20 forming a volume which encloses at least one following lower plate.

This means that the shields 19, 20 can form volumes that are contained within one another (“nested” volumes). Some or all of the shields 19, 20 can be cooled by a cryogenic cooler 4 by thermal coupling as mentioned above.

According to an advantageous feature, the cryogenic cooler 4 is of the type which uses a cold source of liquefied cycle fluid such as helium, hydrogen or nitrogen, at least some of the plates 5, 6, 10 being cooled by the cycle gas via a set of heat exchangers in exchange with said plates 5, 6 and with a flow of the cycle fluid. This means that the cryogenic cooler 4 is connected to a cold source located outside the enclosure 2, this cold source supplying a liquefied fluid flow that is cooled outside the enclosure 2, this flow circulates in the cryogenic cooler 4 and is placed in heat exchange with at least some of the plates 5, 6, 10 in the enclosure 2.

The cycle fluid flow is brought into the enclosure via a sealed circuit so that the cycle fluid does not communicate with the interior of the enclosure 2 (unlike in the known wet solutions).

The set of heat exchangers in exchange with said plates 5, 6 comprises, for example, a plurality, for example, of separate heat exchangers mounted on the plates 5, 6. In addition, the exchangers of at least two adjacent plates 5, 6 are preferably connected mechanically (so as to form a single mechanical entity which is introduced into or removed from the enclosure 2).

Preferably, these elements are held together by the rigid pipes for the cycle fluid and/or via additional supports made of thermally insulating material such as glass fiber, and/or via a frame. This allows the set to be inserted and removed in a single, simple operation.

The heat exchangers are, for example, arranged in a line and spaced apart in a distribution direction, for example a stacking direction which is vertical in the operating position in the enclosure 2.

These cooling stages are arranged one above the other in a spaced apart manner, but the heat exchangers are not necessarily aligned on the same vertical axis as shown in the non-limiting example.

The heat exchangers can be mounted in the enclosure 2 via the same passage through the cover 3, for example via the same support flange 15 of the cover 3.

At least some of the set of heat exchangers can be arranged in a sealed casing 21 delimiting, for example, a volume that is independent of the remainder of the volume of the enclosure 2, and which can contain gas at a pressure of between several millibar and several bar, or can be placed under vacuum, that is to say at a pressure below 0.01 mbar.

The heat exchangers can be in exchange with said plates 5, 6 by conduction and direct or indirect contact, for example via at least one of the following: bolting, at least one thermal connecting braid, a clamp, etc.

In the non-limiting example shown, the heat exchangers comprise a block 7 of conductive material, for example of copper, in contact with the plate 5, 6 and a tube 8, 18 or circuit of conductive material which transports the cycle fluid flow (for example made of copper, aluminum or the like).

This tube or circuit can be soldered to the block 7 and/or machined in the block 7 and/or molded in the block 7 and/or cast in the block 7.

Likewise, at least some of the heat exchangers can comprise (especially at the junction between two elements) a layer of gilt configured to increase heat exchange with the plate in question.

As shown schematically in [FIG. 2], the cryogenic cooler 4 which produces the cooling power (cold cycle fluid flow) can comprise a cryogenic refrigerator with a continuous cycle of refrigeration of a cycle fluid.

Such a refrigerator comprises a cycle circuit 11 composed of the following elements arranged in series: a mechanism 12 for compressing the cycle fluid (one or more compressors in series and/or in parallel), at least one member 13 for cooling the cycle fluid (heat exchanger(s)), a mechanism 14 for expanding the cycle fluid (one or more turbine(s) or valve(s) in series and/or in parallel) and at least one member 13 for reheating the expanded cycle fluid (exchanger(s), especially countercurrent exchanger(s) for cooling and reheating two parts of the circuit 11 simultaneously).

The cycle fluid preferably comprises at least one of the following: helium, hydrogen, nitrogen, argon.

The cycle circuit 11 is configured to subject the cycle fluid to a thermodynamic cycle which brings the cycle fluid at at least one cold end of the cycle circuit 11 to a predetermined cold temperature.

The cycle fluid flow which is placed in heat exchange with said plates 5, 6 in the set of heat exchangers comprises at least one fraction of this cycle fluid at the cold temperature. For example, the cooled liquefied fluid which is circulating in the pipes 8, 18 is a portion removed from the flow circulating in the cycle circuit 11.

The device 1 comprises a set of pipes 8, 18 for supplying the fluid from the cycle circuit 11 to the set of exchangers and for returning said fluid from the set of exchangers to the cycle circuit 11 of the refrigerator 4 (through the cover 3).

The cycle circuit 11 can be configured to subject the cycle fluid to a thermodynamic cycle which brings the cycle fluid to a plurality of separate cold temperatures at a plurality of cold ends of the cycle circuit 11.

Thus, a plurality of separate flows of the cycle fluid at said separate cold temperatures can be placed in heat exchange with a plurality of separate plates 5, 6 via respective sets of heat exchangers (two or more).

In the example shown, two sets of pipes 8, 18 supply a cooling power at separate temperatures at two plates 5, 6. The two sets form separate circulation loops of the cycle fluid which come into the enclosure 2.

The device 1 preferably comprises one or more electrically insulating elements 22 which provide electrical insulation between the enclosure 2 and the cold source of the cooler 4 (especially with respect to the electric voltages of the cold source of the cooler 4). For example, insulating elements 22 are interposed at the junction between the tubes or pipes 8, 18 and the flange 15, and/or at an intermediate position along the pipe portion between the cold source of the cooler 4 and the flange 15. These elements 22 can be, for example, sleeves or tube portions 8 made of ceramics or any other suitable material. For example, some of the tubes or pipes 8, 18 include an electrically insulating portion of this type.

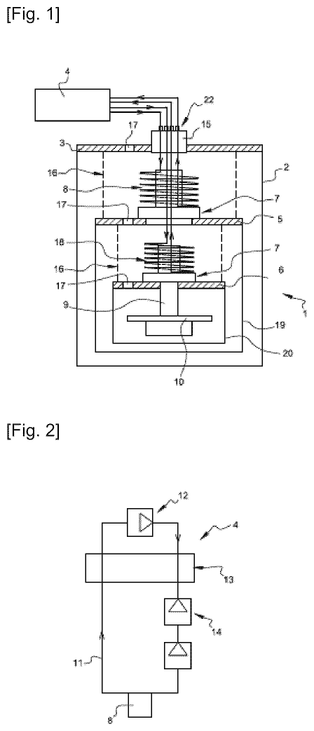

As shown schematically in [FIG. 1], the device can further comprise in the enclosure 2, connected to the plate 6, a sub-kelvin refrigerator 9, for example a dilution refrigerator or a JT (Joule-Thomson) refrigerator, in heat exchange with this at least one plate 10 in order to reach temperatures below 4 K, especially below 1 K, and in particular around the millikelvin.

Such a dilution refrigerator 9 conventionally uses a mixture of helium-3 and helium-4 in a working circuit comprising a boiler, a mixing chamber and a circulating member for the helium flow. The cooling is obtained in the mixing chamber as a result of enthalpy of mixing when the helium-3 is diluted in the helium-4.

For example, the refrigeration device has a working circuit in the form of a loop containing a cycle fluid comprising a mixture of helium-3 (3He) and helium-4 (4He). The working circuit comprises a mixing chamber, a boiler and a fluid transfer member, which are arranged in series and fluidically connected via a first set of pipes. The first set of pipes is configured to transfer cycle fluid from an outlet of the mixing chamber to an inlet of the boiler and from an outlet of the boiler to an inlet of the transfer member. The working circuit comprises a second set of pipes connecting an outlet of the transfer member to an inlet of the mixing chamber. The working circuit comprises at least a first heat-exchange portion between at least some of the first set of pipes and the second set of pipes, this first heat-exchange portion being located between the boiler and the mixing chamber. A cooling member is usually in heat exchange with the working circuit and designed to transfer cold energy to the cycle fluid.

The device 1 thus includes a set of heat exchangers in the enclosure 2 which are cooled by an external cold source which supplies cooling power to 4 K or even to 2 K, in particular via a flow of cryogenic fluid.

This configuration makes it possible to supply more power than a pulse tube.

The cooling can optionally be accelerated by increasing the flow rates of cycle fluid(s) relative to a nominal flow rate. When the device is stopped, it is sufficient to stop the supply of cycle fluid in order to disconnect the cooling power. This is easier than the known wet solutions.

Thus, the structure according to the invention makes it possible to replace a pulse tube with a set of exchangers having the same thermal and mechanical interfaces as in the case of a pulse tube.

As mentioned above, the heat exchangers can be supplied, for example, by a helium refrigerator or liquefier (open or closed loop), or by liquid nitrogen (open or closed loop connected to a liquid nitrogen reservoir) or other liquefied fluid.

The set of exchangers can be installed in any installation that uses a pulse tube. This makes it possible for already existing installations that use pulse tubes to be modified easily.

The invention can make it possible to become free of the rigidity of a pulse tube. The exchangers can be arranged in a horizontal direction and/or mounted in such a manner that they are not attached to one another.

As mentioned above, the set of heat exchangers can have one or more stages (for example one at a temperature of approximately 4 K, approximately 20 K, 50 to 70 K, 80 K, etc.).

This makes it possible for the requirement for cooling power to be stepped according to the temperatures and thus the power necessary for operation of the installation to be limited. The more the device must cool samples, for example qubits, the more valuable it is to add cooling stages of this type.

The set of heat exchangers can be supplied (cooled) by one or more cycle fluid flows at different temperatures. Likewise, the same cycle fluid flow can supply a plurality of cooling stages in series.

In particular towards temperatures of about 4 K, the cycle fluid (typically helium) may be in a supercritical and subcooled state in order to limit the vibrations resulting from the vaporization thereof when it is reheated.

The set of heat exchangers can be inserted into the enclosure via a single branch-T on the flange or top cover. This facilitates installation and optimizes the experimental space in the enclosure.

The set of heat exchangers can be integrated in a volume or space which is separate from the remainder of the enclosure 2 in order to limit the risk of leakage of cycle fluid into the enclosure 2.

The thermal interface between the enclosure 2 and the heat exchangers can be produced by bolting the exchanger to a panel of the associated stage or plate, and/or by means of conductive thermal braids.

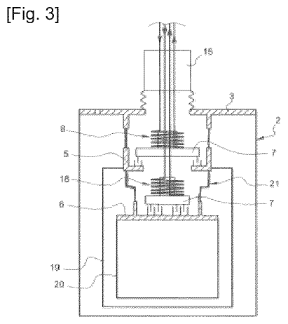

As shown in [FIG. 3], all or some of the heat exchangers can be in exchange with the plates 5, 6 solely by gas exchange of the helium, nitrogen, argon or hydrogen type. The device 1 then preferably comprises one or more heat exchangers arranged in a sealed casing 21 delimiting a gas volume that is independent of the remainder of the volume of the enclosure 2 and in exchange with said plates 5, 6 via the thermal conduction of the gas present in the casing.

In this example, a two-stage exchanger is integrated in the enclosure 2. It allows, for example, one stage or plate to be supplied with a cooling power at a temperature of about 50-70 K with gaseous helium, and another stage/plate to be supplied at about 4 K with supercritical subcooled helium. The helium can be supplied by one or multiple lines, the shields of which are supplied by the return of the reheated gaseous helium.

The heat exchanger(s) can have any other suitable structure. Cf. for example FR3065064A1.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A cryogenic refrigeration device comprising:
an enclosure delimiting a vacuum-sealed volume closed by a cover;
a cryogenic cooler mounted through the cover and having a first end located outside the enclosure and a second end located inside the enclosure, the cryogenic cooler being configured to supply cold at the second end; and
at least two thermally conductive plates distributed in a distribution direction in the enclosure and forming thermal stages,
wherein at least some of the plates are configured to be cooled by the cryogenic cooler to respective predetermined temperatures which decrease in the distribution direction,
wherein at least one of the plates is connected to a thermal shield forming a volume which encloses at least one following plate,
wherein the cryogenic cooler is configured to use a cold source of liquefied cycle fluid, the cooling power of the cryogenic cooler being stored and/or produced at a first end of the cryogenic cooler, at least some of the plates being cooled by the cycle fluid via a set of heat exchangers in heat exchange with said at least some of the plates and with a flow of the cycle fluid which transfers the cooling power from the first end to the second end of the cryogenic refrigerator.

17. The cryogenic refrigeration device as claimed in claim 16, wherein the set of heat exchangers in heat exchange with said plates comprises a plurality of separate heat exchangers associated with the plates, the exchangers of at least two plates being mechanically connected to one another.

18. The cryogenic refrigeration device as claimed in claim 16, wherein said heat exchangers are arranged and spaced apart in the distribution direction, the distribution direction being vertical in the operating position in the enclosure.

19. The cryogenic refrigeration device as claimed in claim 18, wherein said heat exchangers are mounted in the enclosure via the same passage in the cover.

20. The cryogenic refrigeration device as claimed in claim 18, wherein said heat exchangers are mounted in the enclosure via the same support flange of the cover.

21. The cryogenic refrigeration device as claimed in claim 16, wherein the heat exchangers comprise a block of thermally conductive material, for example of copper, in contact with a tube of thermally conductive material, for example of copper, transporting the cycle fluid flow, said tube being soldered to the block and/or machined in the block and/or molded and/or cast in the block.

22. The cryogenic refrigeration device as claimed in claim 16, wherein at least some of the heat exchangers are mounted on the plates and are in heat exchange with said plates by conduction and contact, via at least one of the following: bolting, at least one thermal connecting braid, a clamp.

23. The cryogenic refrigeration device as claimed in claim 16, wherein at least some of the set of heat exchangers are arranged in a sealed casing delimiting a volume that is independent of the remainder of the volume of the enclosure.

24. The cryogenic refrigeration device as claimed in claim 23, wherein at least some of the heat exchangers are in heat exchange with said plates without being in contact with the plates but via an intermediate gas, for example a gas containing at least one of the following: helium, nitrogen, argon or hydrogen.

25. The cryogenic refrigeration device as claimed in claim 16, wherein at least some of the heat exchangers comprise a layer of gilt configured to increase the heat exchange.

26. The cryogenic refrigeration device as claimed in claim 16, wherein the cryogenic cooler comprises:
a refrigerator having a cycle of refrigeration of a cycle fluid, said refrigerator comprising:
a cycle circuit composed of the following elements arranged in series:
a compression mechanism configured to compress the cycle fluid,
a cooling member configured to cool the cycle fluid,
an expansion mechanism configured to expand the cycle fluid, and
a reheating member configured to reheat the expanded cycle fluid,
wherein the cycle fluid comprises at least one of the following: helium, hydrogen, nitrogen, argon, and
wherein the cycle circuit is configured to subject the cycle fluid to a thermodynamic cycle which brings the cycle fluid at at least one end of the cycle circuit to a predetermined cold temperature, and in that the cycle fluid flow in heat exchange with said plates in the set of heat exchangers comprises the cycle fluid at the cold temperature,
wherein the cryogenic refrigeration device further comprises a set of pipes configured to supply at least part of the cycle fluid from the cycle circuit to the set of exchangers and for returning said cycle fluid from the set of exchangers to the cycle circuit of the refrigerator.

27. The cryogenic refrigeration device as claimed in claim 26, wherein the cycle circuit is configured to subject the cycle fluid to a thermodynamic cycle which brings the cycle fluid to a plurality of separate cold temperatures at a plurality of ends of the cycle circuit, and in that a plurality of separate flows of the cycle fluid at said separate cold temperatures are placed in heat exchange with the at least two separate plates via two respective sets of heat exchangers.

28. The cryogenic refrigeration device as claimed in claim 26, wherein the cycle fluid is or contains predominantly helium, the cycle circuit being configured to bring the cycle fluid to at least one of the following cold temperatures: approximately 80 K, between 20 and 70 K, between 2 K and 5 K, and/or into a supercritical state.

29. The cryogenic refrigeration device as claimed in claim 16, wherein the cryogenic cooler comprises a reserve of liquefied cryogenic gas, for example of liquid nitrogen, and a set of pipes for supplying liquefied cryogenic gas from the reserve to the set of exchangers.

30. The cryogenic refrigeration device as claimed in claim 16, further comprising a dilution refrigerator in heat exchange with at least one plate.

31. A method for cryogenic refrigeration of sample(s) using a cryogenic refrigeration device as claimed in claim 16, the method comprising the steps of:
storing and/or producing a cold source of liquefied cycle fluid at the first end of the cryogenic cooler; and
transferring a flow of that cycle fluid from the first end to the second end of the cryogenic cooler, said flow of cycle fluid being placed in heat exchange with the set of heat exchangers at the second end in a sealed manner without communicating with the internal gas volume of the enclosure.

32. The method as claimed in claim 31, wherein the cycle fluid comprises helium or nitrogen.
